(19) United States
(12) Patent Application Publication
(10) Pub. No.: US 2009/0280454 A1
(43) Pub. Date: Nov. 12, 2009

(54) Dental Implant with Bone and Gingival Tissue Preservation Collar

(76) Inventor: Raouf Hanna, Houston, TX (US)

Correspondence Address: Ezra L. Schacht, 1620 West Main Street, Houston, TX, 77006-4712, US

(21) Appl. No.: 12/118,735

(22) Filed: May 11, 2008

(51) Int. Cl. A61C 8/00

(52) U.S. Cl. 433/174

(57) ABSTRACT

Preserving the perigingival site from repeated disturbance by offering a continuous transition through the soft tissue as the external aspect of a dental implant fixture without partitions or gaps. The soft tissue is protected from repeated insertions and removal of an abutment resulting in less bone loss and gingival recession by an integral concave collar while allowing an ample volume of interproximal soft tissue.

### BACKGROUND OF THE INVENTION

Esthetic, hygienic and structural integrity of dental implants rely upon the preservation of crestal bone and soft tissue surrounding the emergence of the implant crown. To date the preservation of soft and hard tissue around dental implants collars has not been achieved. Repeated disturbance of the soft tissue margin surrounding the implant/abutment interface can result in both crestal bone loss and soft tissue recession. The intimate relation between the implant and the gingival margin is preserved in this design with a proximal implant collar integral to the implant to insure mucosal stability, the prevention of peri-implant disease, and a pleasing esthetic outcome.

The subsequent surgical exposure, the trying in and removal of the abutment over time disturbs the intimate indwelling and attachment of the mucosal lining of the soft tissue to the implant and abutment. This often results in the absorption of the crestal bone and a concomitant shrinkage of the soft tissue away from the abutment and overlying prosthesis. Depending upon the amount of disturbance, the loss of bone can exceed 2-3 mm and the shrinkage of soft tissue by a millimeter or two. Exposure of the crown margin and the underlying metallic abutment severely compromises the esthetic appearance especially in anterior teeth. Preserving the gum line is a primary objective for hygienic reasons overall and for preserving or improving a natural smile. This invention addresses these concerns.

At present, the dental professional installs an implant fixture at bone level with the distal end of the implant in the plane of the crestal bone. The abutment, often designed to mimic the natural emergence profile of the replaced tooth, egresses through the soft tissue margin to support a crown. Concerns over the health of the soft tissue and the proper adherence of the soft tissue to the implant and abutment combination have led to several novel inventions.

The subsequent trying in and removal of the abutment over time for impression making and seating of the final crown restoration disturbs the intimate indwelling and attachment of the mucosal lining of the soft tissue to the implant and abutment. No implant/abutment junction is tight enough to prevent the occurrence of a gap known as a microgap in the dental implant literature. The presence of bacteria penetrating this microgap is a proven reason for the tissue loss process. Micromotion occurring between the abutment and the implant causes tissue disruption and resorption of bone during functional loading of the prosthesis. These factors result in a resorption of the crestal bone and a concomitant shrinkage of the soft tissue away from the abutment. Visual exposure of the crown margin and the underlying metallic abutment severely compromises the esthetic appearance. Preserving the gum line is a primary objective for structural and hygienic reasons as well as for preserving or improving a natural smile.

The soft tissue is comprised of a mucosal region with an outer junctional epithelial region and an inner connective tissue region. Interstitial cells adhere the inner connective tissue to both the natural tooth and the supportive bone. The outer region of the junctional epthelia forms a sulcus around the neck of a natural tooth. The present invention offers the least disturbance to these surrounding hard and soft tissues.

Eric Rompen, et al., published US Patent application number US 20070072149 A1, describes a transmucosal component for an implant abutment combination with “a waist shaped or inwardly narrowed part” for maintaining a natural width of biological material to preserve the height of the soft tissue and underlying bone. Rompen teaches both a one-piece implant combining the abutment and implant fixture having this narrowed part, and alternately, a trans-mucosal component in the form of a separate spacer sleeve assigned to the fixture. This separate spacer sleeve is placed between the distal end of the implant and the base of an abutment that, in turn, supports a prosthetic installation.

Rompen teaches the partitioning of the separate spacer sleeve and the implant fixture within the soft tissue at the level of the crestal bone. The current invention remedies the potential for this partition to harbor bacteria or through micromotions to otherwise irritate the surrounding tissues resulting in bone resorption and soft tissue recession. The current invention provides for a smooth, unpartitioned transition through the soft tissue while allowing for multiple try-ins of an abutment.

Recent studies by Dr. Luigi Canullo and Dr. Guilio Raspeerini in The International Journal of Oral and Maxillofacial Implants, Vol. 22, Num. 6, 2007 pp 995, have shown that immediate replacement of an extracted tooth with an implant with abutment and an unloaded provisional crown lessened crestal bone loss by approximately half. In addition, facial and papillar tissue height was the same or better than measurement taken before the procedure. A dental patient might not seek prompt attention or might need more than one implant with multiple try-ins of abutments, resulting in possible stress to the periodontal tissue and bone loss. Another factor is the presence of infection or lack of initial primary stability at the time of tooth extraction to place the implant. This negates the advantages taught in the recent studies. It is posited that inflammation or bacterial invasion induced by these stresses compromise the intended outcome.

The current invention shifts micromotion to well above crestal bone level into the upper sulcus region of the soft tissue. The implant collar envisioned in this patent renders additional support for the abutment and reduces micromotion at the critical junction of soft and hard tissue adhered to the implant surface.

A brief description of the drawings.

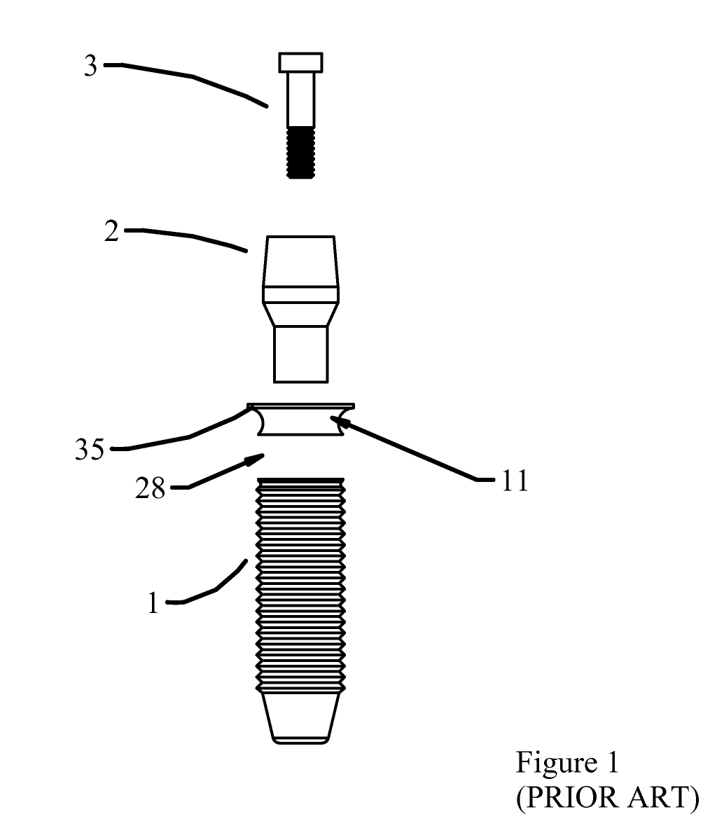

FIG. 1 is an elevated view of prior art implant and spacer;

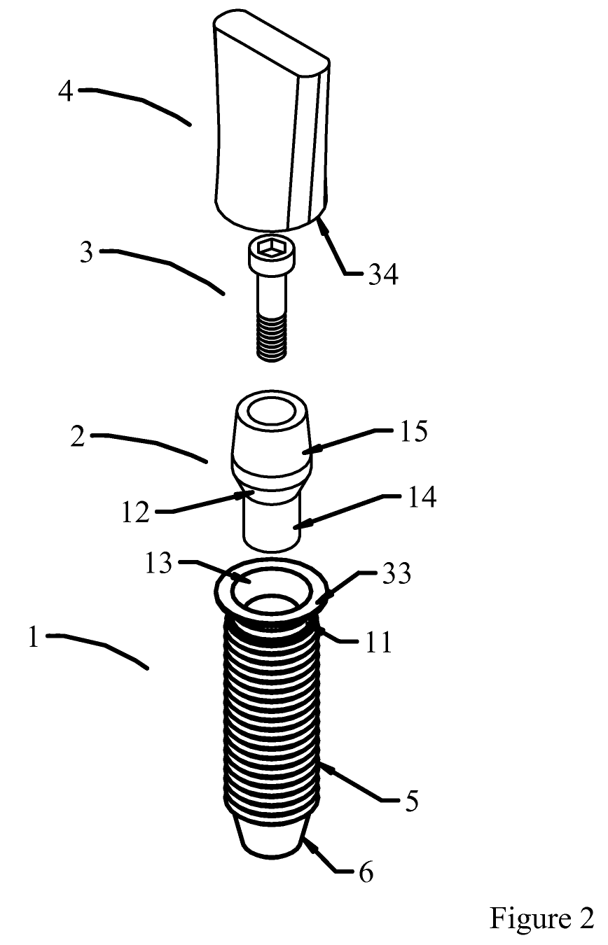

FIG. 2 is an exploded perspective view of an implant with an integral perimucosal protective collar and abutment with retaining screw;

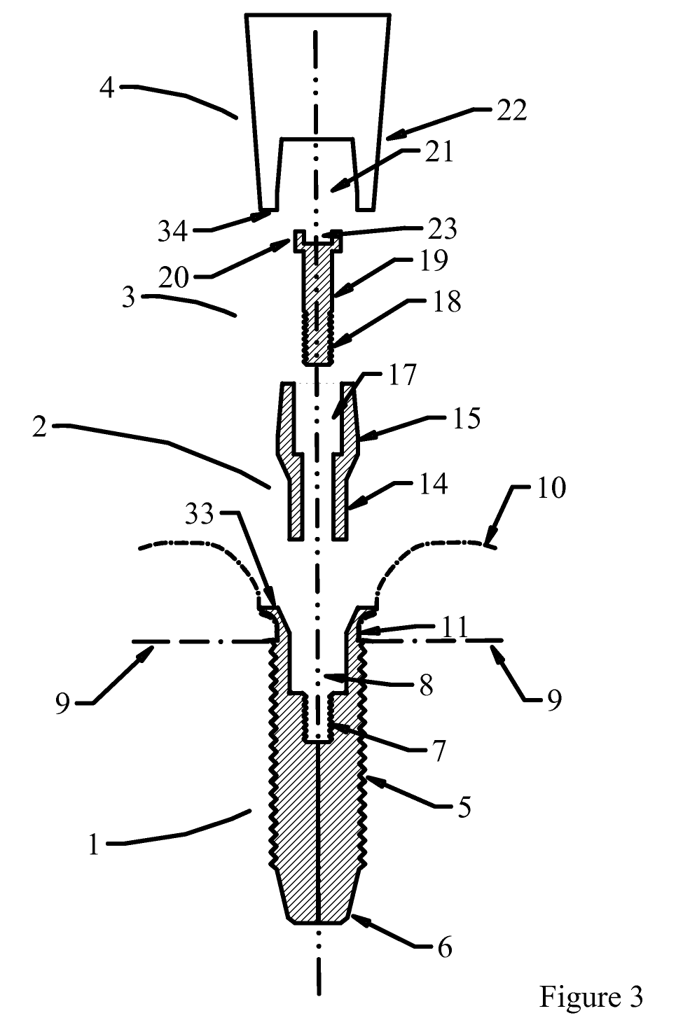

FIG. 3 is an exploded cross-sectional view of the implant, abutment, screw, and prosthesis;

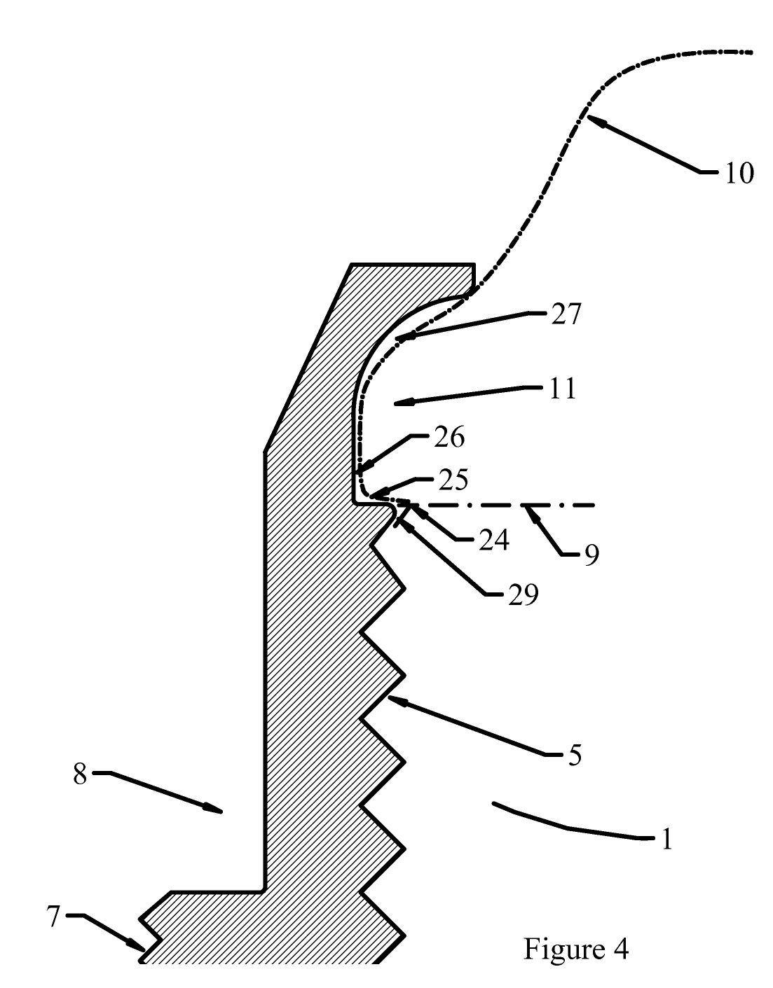

FIG. 4 is a detailed view of the perimucosal region of the implant;

### And,

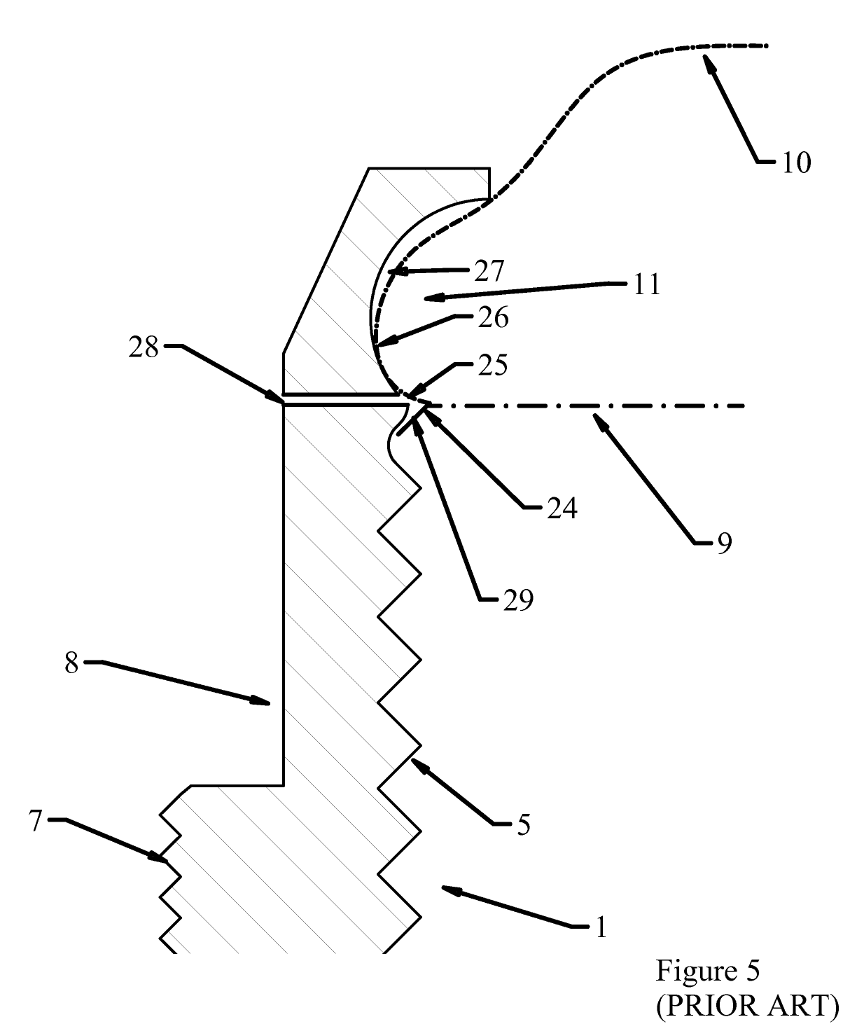

FIG. 5 is a detailed cross-sectioned view of the prior art perimucosal region of the implant, partition gap and abutment in combination.

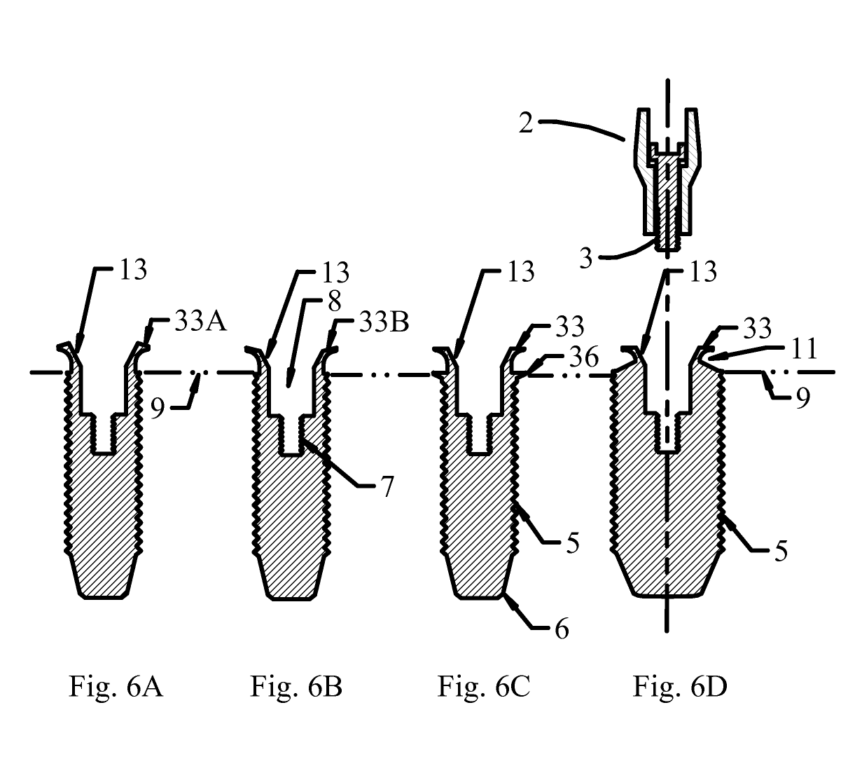

FIGS. 6A through 6D show cross sectional views of implant variations;

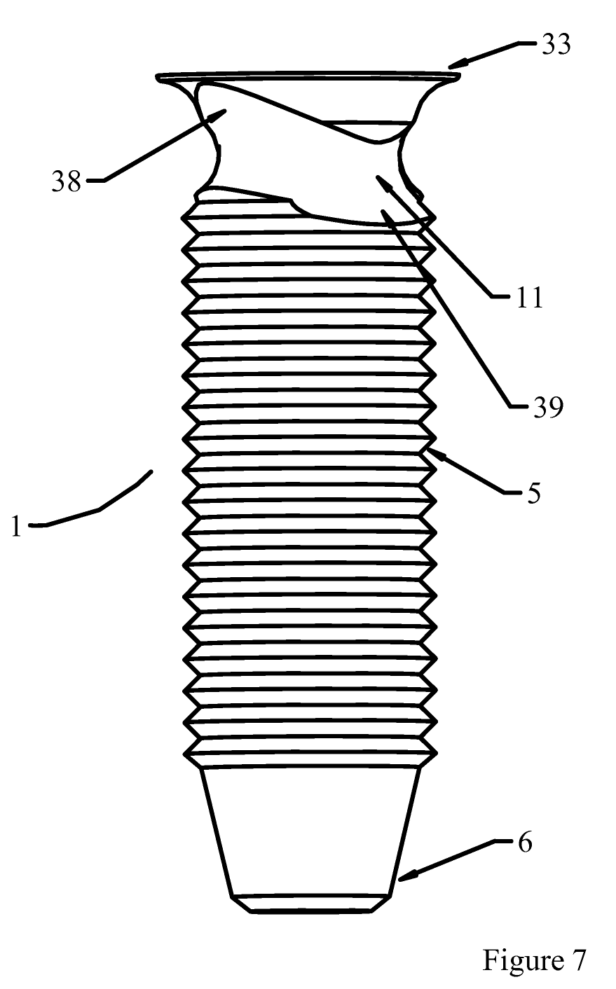

FIG. 7 shows a serpentine, saddle shaped concave curvature;

### And

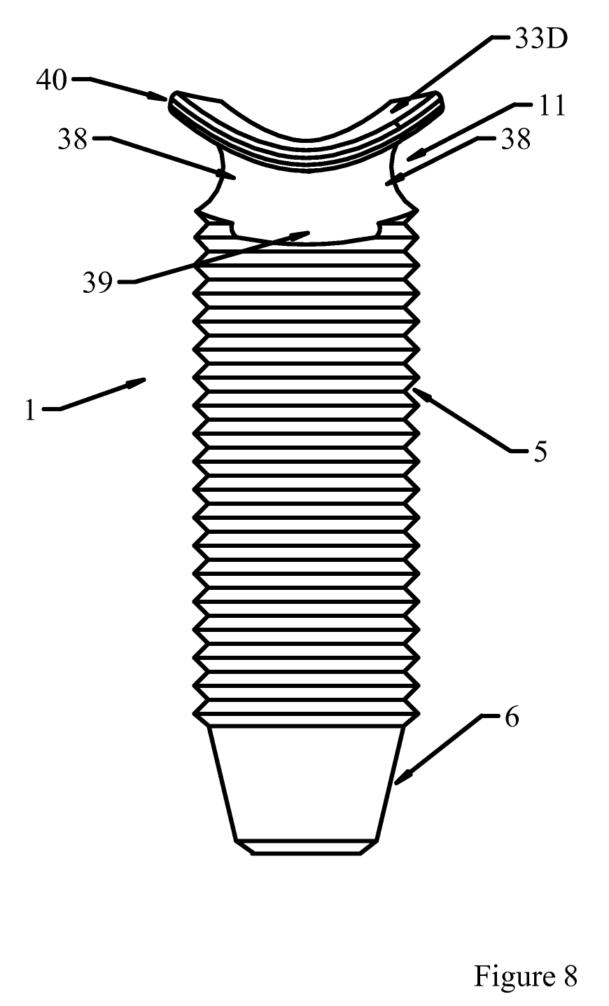

FIG. 8 is an elevated view of an implant having a serpentine curved flange to mate with a similarly curved prosthesis surface.

### DETAILED DESCRIPTION OF THE DRAWINGS

FIG. 1 details the prior art of Eric Rompen, et al., published as US Patent application number US 20070072149 A1, describing an implant 1, a separate collar 35, a partitioned gap 28 mating with the lower surface of the separate collar, an abutment 2 and a retaining screw 3. Region 11 of the separate collar 35 has an inward concave curvature to sustain a necessary volume of soft tissue and to provide a surface compatible with adherent soft tissue.

A necessary improvement to prevent infection or inflammation is shown in FIG. 2 comprised of a generally cylindrical implant 1 having an apex or apical end 6 and an externally threaded region 5 for anchoring in bone, equipped with an integral concave curved region 11 and distal end with an upper flanged surface 33. The implant is set with the concave curved region above the crestal bone level. The abutment 2 can be repeatedly inserted within the implant without disturbing any adherent soft tissue nestled within the concaved region 11. The distal end of the integral concave curvature is disposed radially about the distal end of the implant with the concave curvature installed above the crestal bone to accommodate a healthy volume of soft tissue. The concave region 11 is shown all in one plane parallel to the soft tissue margin but it is understood that this concave region can be a serpentine loop, not all in one plane, to better mimic the emergence profile of a natural tooth and the natural profile of soft tissue attachment. Conic taper 14 on the abutment mates with conic recess 13 within the implant. Projection 12 of the abutment can have one or more flats to clock and lock the abutment within the implant to prevent rotation. Alternately, the abutment and implant can rely upon the mating tapered surfaces to lock the abutment in place by properly tightening the retaining screw 3. A solid abutment incorporating an integral threaded shaft projecting from the abutment lower surface is understood to be an alternate embodiment of this invention. The upper surface 33 of the implant forms a shelf that mates with the undersurface 34 of the prosthesis 4. This optimally places the junction of the prosthesis with the abutment slightly below the soft tissue most distal margin where it remains unseen.

The integral concave region 11 can have a surface, in part or wholly with a roughened or grooved appearance to aid in the adherence of the connective tissue. This surface can have an adherent coating of titanium dioxide, hydroxyapatite, porous fused titanium alloy, or a series of microgrooves machined into the concave surface. These grooves, coatings or surface treatments can be confined to the region of connective tissue adherence. The non-roughened region should have a polished machine finish.

FIG. 3 shows an exploded cross-sectional view of the invention showing the crestal bone margin 9 and the soft tissue margin 13. External recessed region 11 and upper flanged surface 33 form a flared, trumpet-like lip that protects the soft tissue from repeated disturbance in repeated try-ins of an abutment 2 and allows the soft tissue adequate volume and a long enough perimeter along the curvature of recessed region 11 to prevent tissue recession and underlying bone resorption. The internal region of the implant has an internal thread 7 and a recess 8 to accommodate projection 14 of the abutment. The abutment as shown has a stepped through-hole 17 for retaining screw 3. The retaining screw has a shaft 19 with threads 18 to mate with internal threads 7. The retaining screw has a head 20 with driving means 23. Prosthesis 4 has an outer surface 22 and an inner hollow sleeve 21 that seats with surface 15 of the abutment. The margin of the soft tissue reaches above region 22 on the prosthesis.

FIG. 4 details the radially recessed region 11 of the implant where the soft tissue joins the implant. Threaded region 5 is buried within the bone to a level even with the crest 9 of the bone. Regions 24 and 25 form an integrated bond with bone and connective tissue respectively. In the region 26 the soft tissue transitions from adherent connective tissue to a mucosal tissue. Distal to region 27 within the concave curvature, the soft tissue forms a sulcus having close contact with the implant without actual adherence. The whole of region 11 remains undisturbed by multiple placements of the abutment. The underlying bone 29 is protected by the flared lip of the implant, while the concave curvature offers the necessary volume and perimeter depth for healthy soft tissue.

FIG. 5 shows the prior art taught by Rompen, et al., US 20070072149 A1, with a partitioned gap 28 located at the level of the crestal bone 9 with recession of bone in region 29. This region provides a safe haven for micron-sized pathogens. Additionally, with multiple try-ins the shifting collar can disturb the delicate juncture 29 between the soft tissue and the crestal bone.

In alternate embodiments of this invention, FIGS. 6A through 6D show cross sectional views of variations on the region of interest of several implant fixtures. In FIG. 6A, the distal platform 33A of the implant has a convex conical surface to mate with a prosthesis having a mating concave conic surface. In FIG. 6B, the distal platform surface has a concave conical surface 33B to mate with a prosthesis having a convex conical surface.

FIG. 6C shows an extended radial shelf circumscribing the implant in the region of the crestal bone margin to better match the hole made by a countersunk surgical drill. This seats the implant at a preferred level and prevents the implant from being driven below the crestal bone margin, FIG. 6C show a radial ridge 36 to prevent setting the implant too deeply within the bone. This ridge rests at the level of the crestal bone or within a hole drilled with a counter-sink surgical drill at the crestal bone margin 9.

FIG. 6D shows an implant where the substantially cylindrical body of the implant is of a larger diameter than the flared distal end of the implant. FIG. 6D details an exploded view of the narrow distal end diameter of the abutment seated to the implant platform in which the abutment has a narrower diameter than the outer diameter of the implant platform.

FIG. 6D incorporates the recessed region 11 about a larger diameter implant. The flared distal platform 33 has a diameter less than the body of the implant to allow adequate soft tissue height and bone maintenance. It should be noted that the maximum diameter in region 37 of the abutment 2 is less than the maximum diameter of the distal shelf 33 of the implant. This allows the prosthesis (not shown) to seat directly upon the platform 33, which lies just below the soft tissue external margin.

FIG. 7 shows a serpentine, saddle-shaped, concave curvature 11 having the mesial and distal interproximal regions 38 of the curvature placed nearer the implant platform surface 33 to better support and maintain the papilla and interproximal bone. The buccal and lingual regions 39 of the concave curved surface 11 dip toward the apical end 6 of the implant 1 to better mimic the natural profile of soft tissue and bone surrounding a tooth.

FIG. 8 shows an elevated view of an implant 1 having an integral serpentine upper flange with a curved distal surface 33D following the contour of the serpentine, saddle-shaped, concave curvature 11. Surface 33D mates with the prosthesis just below the soft tissue margin. The mesial and distal interproximal regions 38 of curvature 11 are more distal from the apical end 6 of the implant to maintain tissue height. The buccal region 39 and the lingual region on the opposite side of the curvature 11 dip toward the apical end 6 of the implant to better mimic the natural tooth soft and hard tissue interface. Though shown with a large outer diameter of the upper flange 40, an outer diameter less than or equal to the diameter of the body of the implant is within the scope of the invention.

What is claimed is:

1. A dental implant having a generally cylindrical shape with an apical end and a distal end, a mating abutment and a prosthesis, said distal end of said implant comprising an integral concave curvature disposed radially about said distal end of said implant with said concave curvature installed above the crestal bone margin to accommodate a healthy volume of soft tissue and prevent bone loss.

2. A dental implant as in claim 1, comprising a surface coating on at least some part of said concave curvature to promote tissue adherence.

3. A dental implant as in claim 1, comprising a surface of microgrooves on at least some part of said concave curvature to promote tissue adherence.

4. A dental implant as in claim 1, comprising said integral curved concave surface having a serpentine loop, not all in one plane, to better mimic the emergence profile of the natural tooth.

5. A dental implant having a generally cylindrical shape with an apical end and a distal end, a mating abutment and a prosthesis, said distal end of said implant comprising an integral concave curvature disposed radially about said distal end of said implant with said concave curvature installed above the crestal bone margin having a serpentine loop, not all in one plane, the interproximal regions of said serpentine loop more distal to said apical end of said implant than the facial and buccal regions of said serpentine loop.

6. A dental implant as in claim 1, comprising a polished machined surface on the distal end of the implant.

7. A dental implant as in claim 1, comprising a convex conical distal platform to mate with a concave conical prosthesis surface.

8. A dental implant as in claim 1, comprising a concave conical distal platform to mate with a convex conical prosthesis surface.

9. A dental implant as in claim 5, comprising an integral serpentine upper flange having a curved surface following the contour of said integral curved concave surface having said serpentine loop, not all in one plane, the upper surface of said integral serpentine upper flange mating with a prosthesis.
